(19) United States
(12) Patent Application Publication
(10) Pub. No.: US 2007/0067228 A1
(43) Pub. Date: Mar. 22, 2007

(54) Interjurisdictional consumption analysis in transportation applications

(76) Inventor: Cory J. Furman, Regina (CA)

Correspondence Address: KING & SCHICKLI, PLLC, 247 NORTH BROADWAY, LEXINGTON, KY, 40507, US

(21) Appl. No.: 11/525,337

(22) Filed: Sep. 22, 2006

Related U.S. Application Data
(60) Provisional application No. 60/719,363, filed on Sep. 22, 2005.

(51) Int. Cl. G06Q 40/00

(52) U.S. Cl. 705/31

(57) ABSTRACT

A method and system is provided that allows fuelling and jurisdiction crossing data to be captured and transmitted to a central location to be stored. Fuelling data is captured by a fuelling station terminal about fuel purchased by a vehicle at a fuelling station. This fuelling data is then transmitted to a central server where it is stored in a record corresponding to the vehicle. When the vehicle crosses a jurisdiction border, jurisdiction crossing data is captured and this jurisdiction crossing data is transmitted to a central server by a remote device to be stored in a record associated with the vehicle. To generate the necessary information for a fuel tax report, the data stored in the central server and associated with the vehicle is accessed and the desired fuelling metrics are calculated from this data in order to generate the necessary information.

This application claims the benefit of U.S. Provisional Patent Application Ser. No. 60/719,363, filed Sep. 22, 2005, the disclosure of which is herein incorporated by reference.

### TECHNICAL FIELD

This invention is in the field of transportation logistics and, more specifically, deals with a system and apparatus for the automated tracking of the purchase and consumption of fuel between various jurisdictions for the purpose of integrated tax reporting.

### BACKGROUND

In the business of freight carrying, such as long haul trucking, carrier vehicles carrying freight that travel through multiple jurisdiction are required to apportion the fuel taxes between the different jurisdictions based on the distance traveled in each jurisdiction rather than in which jurisdiction the fuel was purchased in.

In North America, a jurisdiction is typically, a state in the U.S. or a province in Canada. The amount of tax placed on the purchasing of fuel for carrier vehicles typically varies from jurisdiction to jurisdiction. Fuel taxes are initially charged when a vehicle purchases fuel at a fueling station. When an operator buys fuel for a vehicle at a fuelling station, the fuelling station charges a fuel tax on top of the costs of fuel in accordance with the fuel tax rate in the jurisdiction that the fuelling station is located in. At this point, the jurisdiction where the fuel is purchased receives the fuel tax based on the fuel tax rate set by that jurisdiction. If nothing further was done, each jurisdiction would collect fuel tax based on how much fuel was purchased within its jurisdiction.

However, fuel tax is apportioned across the jurisdiction on the basis of how much fuel was consumed by a vehicle while traveling through a particular jurisdiction rather than where the vehicle was when it purchased the fuel. This requires a freight carrier to keep extensive records of mileage, fuel purchasers, etc. in to provide fuel tax reporting and allow the jurisdictions to determine the amount of fuel tax owed to the different jurisdictions the vehicle has traveled through.

The International Fuel Tax Agreement (IFTA) is in effect in most U.S states and Canadian provinces and provides requirements for fuel tax reporting. For example, under IFTA a carrier must file a tax report each quarter with the proper authority to report and pay all fuel taxes due to the different jurisdictions through which the carrier operates.

In order to submit the required fuel tax reports and pay the correct apportionment of fuel tax to each jurisdiction the vehicle has traveled through, the driver of the vehicle must accurately keep track of the fuel purchased and the mileage traveled by the vehicle in each particular jurisdiction. Once this information is collected, the driver or the trucking company is required to fill out an extensive set of fuel tax reports on a regular basis with these recordings. These extensive reports are then used to determine how to apportion the tax for the fuel that has been purchased.

As can be imagined, this requires a fair amount of paper work and data to be recorded. It also requires calculation and the submittal of regular reports. The driver must accurately record a lot of information regarding mileage and fuelling and the creation of the reports is quite burdensome.

There are presently a number of methods that can be used to automate this task to some degree and reduce the burden on the trucking company somewhat. There currently are companies that the trucking company can outsource the work to. The trucking company can provide one of these outsourcing companies with all of the information the trucking company has collected and this company can add up all the data and complete the necessary submissions. There is also software in place that allows someone to manually enter all of the necessary data and the software will conduct the proper calculations.

However, none of these prior methods address the problem of the driver of the truck being responsible to accurately record a large amount of information. Even if the calculations are automated, the driver must still keep track of a large amount of specific information. Nor do they address the not insubstantial task of sorting all the recorded information and entering it into one place. The manual sorting and entering alone can add up to many costly man-hours of work.

### SUMMARY OF THE INVENTION

It is an object of the present invention to address problems in the prior art.

In a first aspect of the invention, a system for allocating fuel purchases for a vehicle based upon travel by the vehicle through a plurality of jurisdictions is provided. The system comprises: a central server comprising a database, said database comprising a plurality of fuelling entries and a plurality of jurisdiction entries, each fuelling entry and each jurisdiction entry associated with one of a plurality of specific vehicles, each fuelling entry comprising a fuel amount and each jurisdiction entry identifying at least one of the plurality of jurisdictions; a plurality of fuelling station terminals, each fuelling station terminal associated with a fueling station and operative to capture fueling information, the fuelling information comprising an amount of fuel that was purchased for the vehicle at the fuelling station and each fuelling station operative to communicate captured fueling information to the central server such that the central server can store the transmitted fuelling information in a fuelling entry associated with the vehicle; and a remote device operative to capture jurisdictional crossing information corresponding to the vehicle crossing a border from a first jurisdiction to a second jurisdiction, the jurisdictional crossing information identifying the first jurisdiction and a mileage amount at the time the vehicle crossed the border, the remote device operative to communicate captured jurisdictional crossing information to the central server such that the central server can store the transmitted jurisdictional crossing information in a jurisdictional entry associated with the vehicle. The fuelling entries and jurisdictional entries are used to determine a total amount of fuel purchased for the vehicle within a time period and allocate portions of the total amount of fuel purchased to the jurisdictions within which the vehicle has traveled based on distances traveled by the vehicle in each of the jurisdictions.

In a further aspect of the invention, a method for allocating fuel purchases for a vehicle based upon travel by the vehicle through a plurality of jurisdictions is provided. The method comprises: receiving fueling information that was obtained in response to a purchase of an amount of fuel for the vehicle, from a fuelling station terminal, the fueling information comprising an amount of fuel that was purchased; receiving jurisdiction border crossing information that was obtained in response to the vehicle crossing a jurisdictional border from a first jurisdiction to a second jurisdiction, the jurisdictional border crossing information identifying a mileage amount at a time the vehicle crossed from the first jurisdiction to the second jurisdiction and identifying the first jurisdiction; using the fueling information and jurisdictional border crossing information, determining a total amount of fuel purchased for the vehicle within a time period and allocating portions of the total amount of fuel purchased to the jurisdictions within which the vehicle has traveled based on distances traveled by the vehicle in each of the jurisdictions.

In a further aspect of the invention, a remote device for determining the distance traveled in a plurality of jurisdictions is provided. The remote device comprises: a processor; a memory operatively coupled to the processor; a global positioning system module operative to determine a location of the remote device and operatively coupled to the at least one processor; a program module stored in the memory and operative for providing instructions to the processor, the processor responsive to the instructions of the program module. The program module is operative for: in response to determining the remote device has crossed a border between a first jurisdiction and a second jurisdiction, storing in the memory a mileage amount indicating a distance the vehicle has traveled in the first jurisdiction and associating it with the first jurisdiction.

In a further aspect of the invention, a data processing system for allocating fuel purchases for a vehicle based upon travel by the vehicle through a plurality of jurisdictions. The system comprises: at least one processor; a memory operatively coupled to the at least one processor and containing a database, said database comprising a plurality of fuelling entries and a plurality of jurisdiction entries, each fuelling entry and each jurisdiction entry associated with one of a plurality of specific vehicles, each fuelling entry comprising a fuel amount and each jurisdiction entry identifying at least one of the plurality of jurisdictions; and a program module stored in the memory and operative for providing instructions to the at least one processor, the at least one processor responsive to the instructions of the program module. The program module is operative for: in response to receiving fuelling information captured by one of a plurality of fuelling station terminals such, each fuelling station terminal associated with a fueling station, the fuelling information comprising an amount of fuel that was purchased for the vehicle at the fuelling station, storing the fuelling information in a fuelling entry associated with the vehicle; in response to receiving jurisdiction crossing information captured by a remote device related to the vehicle crossing a border from a first jurisdiction to a second jurisdiction, the jurisdictional crossing information identifying the first jurisdiction and a mileage amount at the time the vehicle crossed the border, store the received jurisdiction crossing information in a jurisdiction entry associated with the vehicle; and using the fuelling entries and jurisdictional entries associated with the vehicle, determining a total amount of fuel purchased for the vehicle within a time period and allocate portions of the total amount of fuel purchased to the jurisdictions within which the vehicle has traveled based on distances traveled by the vehicle in each of the jurisdictions.

Each of the plurality of fuelling station terminals is typically located at a fuelling station where a vehicle operator can purchase fuel for his or her vehicle. As the vehicle operator is fuelling his or her vehicle and is completing the fuelling transaction, the fuelling station terminal will capture relevant data associated with the fuelling transaction, such as the amount of fuel purchased, tax amount paid, etc. This captured data will then be transmitted to the central server where it is used to create a fuelling entry in a record corresponding to the particular vehicle. In this manner, when an operator of a vehicle purchases fuel for his or her vehicle, the relevant information related to fuelling a vehicle that is necessary to produce the necessary fuel tax reports is captured at the time of the fuelling and transmitted to a central server where it is stored.

Information related to the crossing of jurisdictional borders is captured and transmitted to the central server using a remote device. When the vehicle crosses a jurisdictional border, a remote device is used to capture the relevant information regarding the border crossing including what border was crossed and the odometer reading at the time the border was crossed. This information is then transmitted to the central server to be stored with the fuelling entries.

The remote device can be located separate from the vehicle and the operator of the vehicle could manually record the required information when the vehicle crosses a jurisdictional border, such as by entering the information in a logbook, and then once the operator has access to the remote device, entering the information into the remote device. Alternatively, the remote device could be located in the vehicle and the information directly entered into the remote device by the operator. In a further embodiment all or some of the necessary information is captured by a remote device equipped with a global positioning system module to determine when the vehicle is crossing a jurisdictional border.

As the operator of the vehicle continues to purchase fuel and cross jurisdictional borders, this information is captured by fuelling station terminals and remote devices respectively and is transmitted back to the central server to be stored in a central record.

A fuel tax report can then be generated using the information stored solely on the central server. When a tax report, in order to pay the correct apportionment of fuel tax to the various jurisdictions the vehicle has travelled through, or other fuel consumption related data is desired all of the data collected in the central server regarding fuelling of the vehicle and crossing jurisdictional borders can be accessed and the necessary calculations and metrics determined.

If the capturing of the data by the remote device requires the operator of the vehicle to input some of the information manually into the remote device, the central server can use the data stored regarding the border crossings and fuellings of the vehicle to determine whether the data received is realistic. For example, odometer readings at the fuelling stations could be checked against odometer readings at jurisdictional border crossing to see if the data is possible.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic illustration of an embodiment of a central server in accordance with the present invention;

FIG. 2 is a schematic illustration of an embodiment of an overall system for gathering interjurisdictional fuelling information in accordance with the present invention;

FIG. 3 is a schematic illustration of an embodiment of a fuelling station terminal, in accordance with the present invention; and

FIG. 4 is a schematic illustration of an embodiment of a remote device comprising a GPS module, in accordance with the present invention.

FIG. 5 is a flowchart illustrating a method for gathering interjurisdictional fueling information in accordance with an aspect of the present invention.

### DETAILED DESCRIPTION OF THE ILLUSTRATED EMBODIMENTS

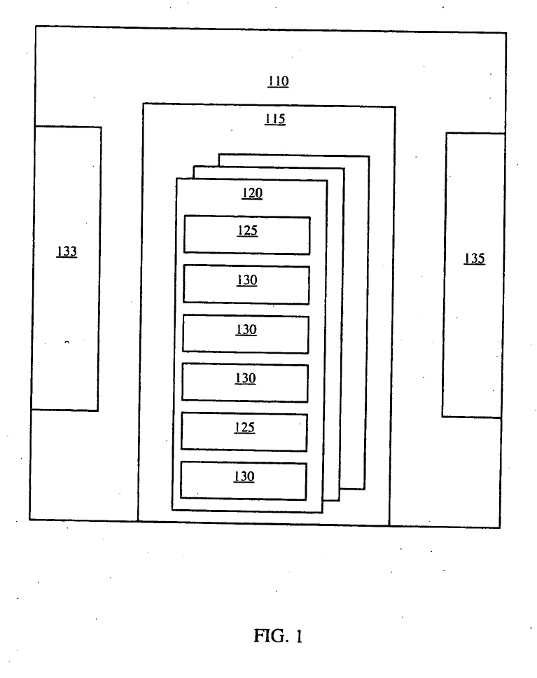

FIG. 1 illustrates a schematic of a central server 110. The central server 110 comprises a database 115. Database 115 comprises a plurality of fuelling records 120. Each fuelling record 120 corresponds to a specific vehicle. Each fuelling record 120 consists of one or more fuelling entries 125 and one or more jurisdiction entries 130. The central server 110 also has a fuelling station terminal interface 133 and a remote device interface 135.

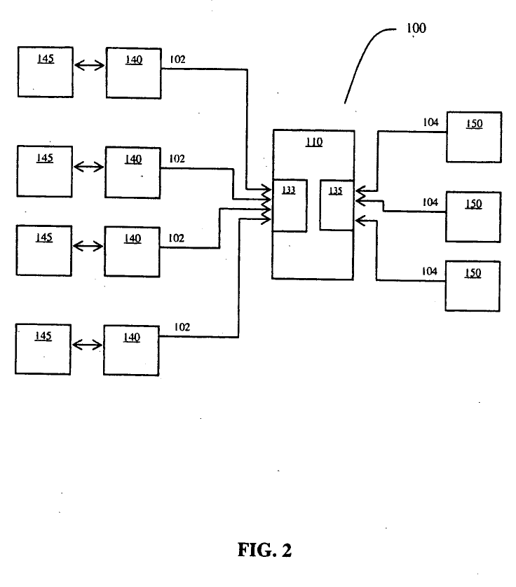

FIG. 2 illustrates a schematic of a fuel data capturing system 100, in accordance with an embodiment of the present invention. The system 100 comprises a central server 110, a plurality of fuelling station terminals 140 and at least one remote device 150.

Each of the plurality of fuelling station terminals 140 is located at a fuelling station and is capable of communicating with the central server 110 through the fuelling station interface 133 of the central server 110.

The fuelling station terminal 140 would be located at a fuelling station where a fuelling transaction would take place. A vehicle would purchase fuel at the fuelling station by filling up the vehicle using a fuel pump. Generally, although not necessarily, each fuelling station terminal 140 would operatively be in communication with a fuel pump 145 for pumping a fuel (such as diesel) into a vehicle.

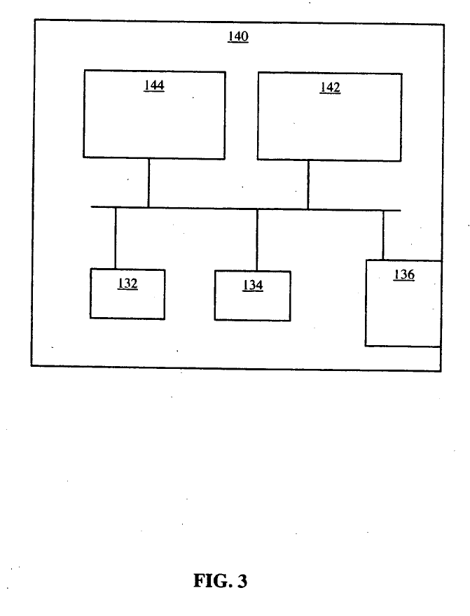

FIG. 3 is a schematic illustration of a fuelling station terminal 140. The fuelling station terminal 140, typically comprises a processing unit 132, a memory 134, a communication link 136, an input device 142 and a display device 144.

The processing unit 132 is a microprocessor as commonly known in the art that is operative to control the operation of the fuelling station terminal 140 and to read data from the memory 134 and write data to the memory 134. The memory 134 contains program instructions operative to be read by the processing unit 132 and instruct the processing unit 132 how to operate.

The fuelling station terminal 140, typically, comprises an input device 142 such as a keypad so data can be input into the fuelling station terminal 140 manually, at the time the fuel is purchased by a vehicle operator and a screen 144 to prompt the operator to enter any necessary information and allow the operator to interact with the fuelling station terminal 140. Each fuelling station terminal 140 is configured to operate in association with at least one set of fuel pumps and is able to record certain fuelling data.

Typically, this fuelling data comprises the following information: a fuel amount, which corresponds to the amount of fuel that is pumped into a vehicle at the fuelling station; a vehicle identifier, that the user can input through the input device 142 and identifies the specific vehicle that has purchased the fuel; tax data, which indicates the amount of tax paid on the fuel purchased at the fuelling station; optionally, an odometer reading, that the user could input through the input device 142 and corresponds to the odometer reading of the vehicle that the fuel was purchased for; and, optionally, a time stamp, indicating when the transaction took place.

Referring again to FIG. 2, once the fuelling station terminal 140 has collected the fuelling data for a particular fuel transaction, the fuelling data and a location identifier are transmitted to the central server 110 through the fuelling station terminal interface 133 in a fuelling data transmission 102. The location identifier could identify the particular fuelling station where the fuelling station terminal 140 is located or alternatively, it could simply identify the jurisdiction the fuelling station terminal 140 is located in.

Typically, the fuelling station terminal interface 133 would be a network card as is commonly known in the art and the central server 110 would then communicate with the fuelling station terminal 140 through a network connection, such as the internet, either by sending the fuelling data transmission 102 by email or through a real time connection to the fuelling station terminal 140. Alternatively, the fuelling station terminal interface 133 could be a disk drive, cd-rom, dvd-rom or other input device known in the art and the fuelling data stored by the fuelling station terminal 140 can be stored on a known corresponding storage medium at the fuelling station. This storage media containing the fuelling data could then be physically transported to the central server 110 and the fuelling data transmission 102 could occur by the fuelling station terminal interface 133, which would be a reader for the storage media used, reading the fuelling data from the storage media.

Referring to FIG. 1, upon receiving a fuelling data transmission 102 from a fuelling station terminal 140, the central server 100 stores the fuelling data in the database 115. The central server 110 uses the vehicle identifier transmitted by the fuelling station terminal 140 to determine the correct fuelling record 120 in the database 115 to store the fuelling data in and then adds the fuelling data to the record 120 as a fuelling entry 125.

Referring again to FIG. 2, jurisdiction crossing entries 130 are created using jurisdiction crossing data forwarded to the central server 110 by a remote device 150 in a jurisdiction crossing data transmission 104. The remote device 150 is operative to communicate with the central server 110 through the remote device interface 135. The remote device 150 could be a personal computer, PDA or other mobile computing device operably connectable to the remote device interface 135 of the central server 110 through the remote device interface 135 such that the remote device 150 is in communication with the central server 110.

The remote device 150 is capable of receiving jurisdiction crossing data and using this jurisdiction crossing data to create a jurisdiction crossing transmission 104 for transmittal to the central server 110. This jurisdiction crossing data typically comprises: an odometer reading of the vehicle, at the time when the vehicle crossed a jurisdictional border; a border identifier, to identify the border crossed; a vehicle identifier, associated with the vehicle that crossed the jurisdictional border; and, optionally, a time stamp.

The border identifier could identify a jurisdictional border by use of a border code indicating a specific border or alternatively, identifying the first jurisdiction that was left and the second jurisdiction that was entered.

The remote device 150 transmits the jurisdiction crossing data in a jurisdiction crossing data transmission 104 to the central server 110, through the remote device interface 135 of the central server 110.

Typically, the remote device interface 135 would be a network card as is well known in the art and the remote device 150 and the central server 100 would be in communication over a network, such as the internet. The jurisdiction crossing data transmission 104 could take the form of: an email, emailing the jurisdiction crossing data to the central server 110; a direct network connection; or any other means, as is known in the art. Alternatively, the remote device 150 could communicate over a telephone line to the central server 110 which the remote device 150 could use to directly connect to the central server 110 and the remote device interface 135 could be a modem.

Upon receiving the jurisdiction crossing transmission 104, the central server 110 uses the vehicle identifier to determine the record 120 associated with the vehicle and creates a jurisdiction entry 130, using the jurisdiction crossing data in the jurisdiction crossing data transmission 104 to the fuelling record 120 corresponding to the vehicle identifier.

In one embodiment of the invention, a driver of the vehicle determines when the vehicle is crossing a jurisdictional border and manually records the odometer reading of the vehicle and the border that has been crossed. In this embodiment, the remote device 150 can be either a portable computing device that is carried in the vehicle allowing the operator of the vehicle to manually enter this information when the vehicle has crossed the jurisdictional border or, alternatively, the remote device 150 can be a typical computer system, located on a premise separate from the vehicle, that the operator inputs the information recorded at the border crossing into at a later time. The remote device 150 can be located in a premise away from the vehicle and the operator of the vehicle can manually record the required information into a log book to be later entered into the remote device 150, when the operator of the vehicle later has access to the remote device 150.

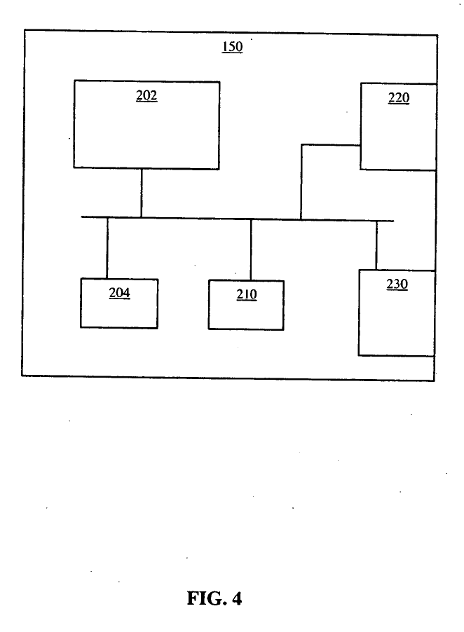

A further embodiment of the remote device 150 is schematically illustrated in FIG. 4. In this embodiment, the remote device 150 is a portable device carried in the vehicle and comprises: a processing unit 202; a memory 204; and a global positions system module 210 and optionally, a vehicle management interface 220 and a communication link 230.

The processing unit 202 is a microprocessor as commonly known in the art that is operative to control the operation of the remote device 150 and to read data from the memory 204 and write data to the memory 204. The memory 204 contains program instructions operative to be read by the processing unit 202 and instruct the processing unit 202 how to operate. In addition, the memory 204 will contain map data allowing the remote device 150 to correlate position data from the global positioning system module 210 to a physical location using the map data.

The global positioning system module 210 is operative to regularly receive position data from global positioning system satellites to allow the remote device 150 to determine its position. The remote device 150 will periodically determine its position using the global positioning system module 210 and determine its location in reference to the map data stored in the memory 204. When the remote device 150 determines that it is crossing a jurisdiction border, the remote device 150 will determine a mileage amount and store the mileage amount and the data identifying the border that was crossed in the memory 204. The mileage amount can be either: the odometer reading of the vehicle when the vehicle crossed the border or the distance the vehicle travelled in the jurisdiction it just left. If the mileage amount is an odometer reading, the remote device 150 typically stores both data identifying the border crossed, the odometer reading and optionally a time stamp. Alternatively, if the mileage amount is the distance travelled by the vehicle in the jurisdiction that the vehicle left when the vehicle crossed the border, a mileage amount for each jurisdiction the vehicle has travelled in can be stored in the memory 204 and the distance travelled can be added to the distance already saved for the jurisdiction the vehicle just left, keeping a total of the total distance travelled in each jurisdiction in the memory 204 rather than creating a separate record in the memory 204 each time the vehicle crosses a border and leaves a jurisdiction.

The remote device 150 could determine the odometer reading of the vehicle by prompting the operator to manually enter the odometer reading into the remote device 150 when the vehicle crosses a jurisdictional border. Alternatively, the remote device 150 could use the repeatedly collected position data from the global positioning system module 210 to determine the distance travelled by the vehicle. In a further alternative embodiment, if the remote device 150 comprises a vehicle management interface 220, the remote device 150 could use the vehicle management interface 220 to access a vehicle management system in the vehicle and access the data values recorded by the vehicle management system to determine the distance travelled by the vehicle.

The remote device 150 transmits data to the central server 110 using the communication link 230. The communication link can comprise a data writing device operative to write the recorded data into a data file to transfer to the central server 110 or the remote device 150 can comprises a wireless communication device or connection to a network that allows the data to be transferred to the central server 110.

Referring to FIGS. 1 and 2, the central server 110 having received fuelling data from fuelling station terminals 140 and jurisdiction crossing data from remote devices 150, contains a plurality of fuelling records 120. Each of the fueling records 120 located in database 115 of the central server 110 is associated with a specific vehicle. Each fuelling record 120 is identified by a vehicle identifier that corresponds to the vehicle the record is for. The fuelling entries 125 are created using fuelling data communicated to the central server 110 from a fuelling station terminal 140 in a fuelling data transmission 102. The jurisdiction entries 130 are created using jurisdiction crossing data communicated to the central server 110 from the remote device 150 in a jurisdiction crossing transmission 104. As outlined above, each fuelling entry 125 typically comprises the following data fields: a fuel amount; tax data; optionally, an odometer reading; optionally, a location identifier; and optionally, a time stamp. As outlined above, if the mileage amounts captured by the remote device 150 are in the form of an odometer reading, each jurisdictional crossing entry 130 typically comprises the following data fields: an odometer reading; a border identifier; and optionally, a time stamp and a separate jurisdictional crossing entry 130 is typically created for each time the vehicle crossed a border between a first jurisdiction and a second jurisdiction. If the mileage amounts captured by the remote device 150 are in the form of the distance travelled by the vehicle in a jurisdiction, there is typically only a single jurisdiction entry 130 for each jurisdiction the vehicle has travelled through and the sum of all the distances travelled in a jurisdiction are stored in the jurisdiction entry 130 associated with that jurisdiction. In this manner, even though a vehicle may leave and re-enter a jurisdiction many times, with a different distance travelled in the jurisdiction each time the vehicle passes through the jurisdiction, the jurisdiction entry 130 associated with that jurisdiction would contain the sum of all the distance travelled by the vehicle as it passed through that jurisdiction.

A record 120 corresponding to a vehicle and identified by the vehicle's vehicle identifier would contain a number of fuelling entries 125 and jurisdiction crossing entries 130. If odometer readings are associated with each of the fuelling entries 125 and jurisdictional crossing entries 130 the odometer reading would allow the record to be sorted by numerical ordering based on the odometer readings. Each record 120 would contain a complete data field allowing the calculation of the mileage of a vehicle as it crosses the different borders, the consumption of fuel between fuelling stops, the taxes paid overall and in which jurisdictions and other information.

In addition, if some of the data captured for the fuelling records 120 is entered manually by an operator of the vehicle or other user, the data in the fuelling record 120 can be used to determine the feasibility of the data. For example, the central server can verify the odometer readings of the fuelling entries 125 and the jurisdiction crossing entries 130 against the locations where these fuelling entries 125 and jurisdiction crossing entries 130 originated. In this manner, the central server 110 can verify whether manual inputs into the remote device 150 or the fuelling station terminal 140 are accurate.

When a user wishes to calculate values related to a specific vehicle such as the mileage travelled in a jurisdiction, the amount of fuel consumed overall, the amount of fuel consumed over a set distance, the approximate amount of fuel consumed in a jurisdiction or the taxes paid in each jurisdiction, the data saved in the fuelling record 120 allows these values to be calculated. In this manner, the central server 110 can use the fuelling records 120 to calculate fuel consumption related metrics of a specific vehicle in order to allow the user to prepare the necessary fuel reports. For example, the fuelling entries and jurisdictional entries can be used to determine the total amount of fuel purchased for the vehicle within a time period and allocating portions of the total amount of fuel purchased to the jurisdictions within which the vehicle has traveled based on distances traveled by the vehicle in each of the jurisdictions. The information stored in the central server and the allocation of the total distance travelled to different jurisdictions can then be used to apportion the tax already paid for fuel to the different jurisdictions and determine what tax is owing to which jurisdictions and/or what tax can be reclaimed.

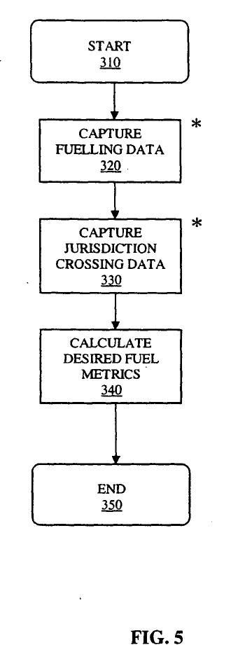

FIG. 5 is a flowchart illustrating a method contemplated by the present invention and implemented using a system, such as the system described above. The method 300 comprises the steps of: starting 300; repeatedly capturing fuelling data 310; repeatedly capturing jurisdiction crossing data 320; calculating fuelling metrics 330; and ending 340.

The method starts 300 and captures fuelling data 310 and jurisdiction crossing data 320.

Fuelling data is captured 310 when a vehicle purchases fuel at a fuelling station. Typically, the fuelling data 310 is captured at the fuelling station and transmitted to a central location for storage. As described in more detail above, this data typically comprises among other information, the amount of fuel purchased, the taxes paid and an identification of either the fuelling station where the fuel was purchased or the jurisdiction the fuelling station is located in. Additionally, a time stamp or an odometer reading of the vehicle may also be captured in this step. Fuelling data is captured 310 repeatedly each time the vehicle purchases fuel at a fuelling station and may step 310 may be repeated a number of times.

Jurisdiction crossing data is captured 320 regarding information involved in the vehicle crossing a jurisdiction border is also repeated captured. As described in more detail above, this data typically comprises the odometer reading of the vehicle when it crossed the jurisdiction border and an identification of the jurisdiction border that was crossed. Optionally, this data might further comprise a time stamp, indicating when the vehicle crossed the jurisdiction border.

Although FIG. 5 illustrates step 310 (capturing fuelling data) preceding step 320 (capturing jurisdiction crossing data), however, it is to be understood that both steps 310 and 320 happen repeatedly and can occur in any order. For example, step 310 could occur when a vehicle fills up with fuel, then step 320 could occur twice, when the vehicle crosses two jurisdiction borders to be followed by another step 310 when the vehicle purchases some more fuel.

After steps 310 and 320 have typically occurred a number of times each, the desired fuel metrics will be calculated 330 to determine the necessary information to generate the necessary fuel tax reports. As described above these metrics could include the mileage travelled in a jurisdiction, the amount of fuel consumed overall, the amount of fuel consumed over a set distance, the approximate amount of fuel consumed in a jurisdiction or the taxes paid in each jurisdiction and the method will end 340.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. A system for allocating fuel purchases for a vehicle based upon travel by the vehicle through a plurality of jurisdictions, the system comprising:
a central server comprising a database, said database comprising a plurality of fuelling entries and a plurality of jurisdiction entries, each fuelling entry and each jurisdiction entry associated with one of a plurality of specific vehicles, each fuelling entry comprising a fuel amount and each jurisdiction entry identifying at least one of the plurality of jurisdictions;
a plurality of fuelling station terminals, each fuelling station terminal associated with a fueling station and operative to capture fueling information, the fuelling information comprising an amount of fuel that was purchased for the vehicle at the fuelling station and each fuelling station operative to communicate captured fueling information to the central server such that the central server can store the transmitted fuelling information in a fuelling entry associated with the vehicle; and
a remote device operative to capture jurisdictional crossing information corresponding to the vehicle crossing a border from a first jurisdiction to a second jurisdiction, the jurisdictional crossing information identifying the first jurisdiction and a mileage amount at the time the vehicle crossed the border, the remote device operative to communicate captured jurisdictional crossing information to the central server such that the central server can store the transmitted jurisdictional crossing information in a jurisdictional entry associated with the vehicle;
wherein the fuelling entries and jurisdictional entries are used to determine a total amount of fuel purchased for the vehicle within a time period and allocate portions of the total amount of fuel purchased to the jurisdictions within which the vehicle has traveled based on distances traveled by the vehicle in each of the jurisdictions.

2. The system of claim 1 wherein one of the fuelling station terminals is operatively connected to at least one fuel pump such that the amount of fuel that was purchased is automatically determined by the fuelling station terminal based on an amount of fuel dispensed by the at least one fuel pump.

3. The system of claim 1 wherein the fueling information further comprises an identification of the vehicle and the fuelling station terminals comprises an input device and wherein an operator of the vehicle inputs a vehicle identifier to the fuelling station terminal to be used as the identification of the vehicle in the fuelling information.

4. The system of claim 1 wherein the remote device computer is one of: a personal computer operative to communicate with the central server through an internet connection; and a mobile PDA.

5. The system of claim 1 wherein the remote device is located in the vehicle.

6. The system of claim 5 wherein the remote device comprises a global positioning system module and wherein the remote device automatically obtains the jurisdictional crossing information in response to the vehicle crossing the border.

7. The system of claim 6 wherein the mileage amount is a distance traveled by the vehicle in the first jurisdiction as determined by the global position positioning module.

8. The system of claim 5 wherein the remote device comprises a global positioning system module and wherein the mileage amount is a distance traveled by the vehicle while the vehicle was traveling in the first jurisdiction as determined by the global positioning system module.

9. The system of claim 1 wherein the mileage amount is an odometer reading of the vehicle when the vehicle crossed the border.

10. The system of claim 1 wherein the mileage amount is a distance traveled by the vehicle in the first jurisdiction.

11. The system of claim 5 wherein the remote device further comprises a vehicle management interface operatively connectable to a management system of the vehicle and wherein the mileage amount is the distance traveled by the vehicle in the first jurisdiction as determine from the management system.

12. The system of claim 5 wherein the remote device further comprises a vehicle management interface operatively connectable to a management system of the vehicle and wherein the mileage amount is an odometer reading of the vehicle as determine from the management system.

13. The system of claim 1 wherein a jurisdiction entry is created for the vehicle for each time the vehicle crosses a border between a first jurisdiction and a second jurisdiction.

14. The system of claim 7 wherein a single jurisdiction entry is created for each jurisdiction the vehicle has traveled in, each jurisdiction entry comprising a mileage total, and wherein in response to the central server receiving jurisdiction crossing information from the remote device that identifies a jurisdiction for which a jurisdiction entry has already been created, adding the mileage amount to the total mileage stored in the jurisdiction entry.

15. The system of claim 8 wherein a single jurisdiction entry is created for each jurisdiction the vehicle has traveled in, each jurisdiction entry comprising a mileage total, and wherein in response to the central server receiving jurisdiction crossing information from the remote device that identifies a jurisdiction for which a jurisdiction entry has already been created, adding the mileage amount to the total mileage stored in the jurisdiction entry.

16. The system of claim 1 wherein each fuel entry further comprises a location identifier, the location identifier identifying a location of the fueling station that captured the fueling information stored in the fuel entry.

17. The system of claim 1 wherein the fuelling information further comprises a time stamp, the time stamp indicating a time the amount of fuel was purchased.

18. The system of claim 1 wherein the remote device can upload jurisdiction crossing information to the central server.

19. The system of claim 1 wherein the remote device uploads jurisdiction crossing information automatically to the central server through a communication link.

20. The system of claim 1 wherein the fuelling information further comprises an amount of tax paid for the purchased fuel and the allocations to the jurisdictions of the portions of the total amount of fuel purchased are compared to the amount of tax paid in each jurisdiction to allocate a tax balance for each jurisdiction.

21. The system of claim 20 wherein the system uses the allocations to the jurisdictions of the portions of the total amount of fuel purchased to generate summary reports.

22. The system of claim 20 wherein the system uses the allocations to the jurisdictions of the portions of the total amount of fuel purchased to generate fuel tax reports.

23. The system of claim 22 wherein the generated fuel tax reports are electronically filed.

24. A method for allocating fuel purchases for a vehicle based upon travel by the vehicle through a plurality of jurisdictions, the method comprising:
receiving fueling information that was obtained in response to a purchase of an amount of fuel for the vehicle, from a fuelling station terminal, the fueling information comprising an amount of fuel that was purchased;
receiving jurisdiction border crossing information that was obtained in response to the vehicle crossing a jurisdictional border from a first jurisdiction to a second jurisdiction, the jurisdictional border crossing information identifying a mileage amount at a time the vehicle crossed from the first jurisdiction to the second jurisdiction and identifying the first jurisdiction;
using the fueling information and jurisdictional border crossing information, determining a total amount of fuel purchased for the vehicle within a time period and allocating portions of the total amount of fuel purchased to the jurisdictions within which the vehicle has traveled based on distances traveled by the vehicle in each of the jurisdictions.

25. The method of claim 24 wherein the fuelling information further comprises an amount of tax paid for the purchased fuel and the allocations to the jurisdictions of the portions of the total amount of fuel purchased are compared to the amount of tax paid in each jurisdiction to allocate a tax balance for each jurisdiction.

26. The method of claim 25 further comprising generating summary reports using the allocations to the jurisdictions of the portions of the total amount of fuel purchased.

27. The method of claim 25 further comprising generating fuel tax reports using the allocations to the jurisdictions of the portions of the total amount of fuel purchased to generate fuel tax reports.

28. The method of claim 27 further comprising automatically filing the generated fuel tax reports electronically.

29. A remote device for determining the distance traveled in a plurality of jurisdictions, the remote device comprising:
a processor;
a memory operatively coupled to the processor;
a global positioning system operative to determine a location of the remote device and operatively coupled to the at least one processor;
a program module stored in the memory and operative for providing instructions to the processor, the processor responsive to the instructions of the program module, the program module operative for:
in response to determining the remote device has crossed a border between a first jurisdiction and a second jurisdiction, storing in the memory a mileage amount indicating a distance the vehicle has traveled in the first jurisdiction and associating it with the first jurisdiction.

30. A data processing system for allocating fuel purchases for a vehicle based upon travel by the vehicle through a plurality of jurisdictions, the system comprising:
at least one processor;
a memory operatively coupled to the at least one processor and containing a database, said database comprising a plurality of fuelling entries and a plurality of jurisdiction entries, each fuelling entry and each jurisdiction entry associated with one of a plurality of specific vehicles, each fuelling entry comprising a fuel amount and each jurisdiction entry identifying at least one of the plurality of jurisdictions; and
a program module stored in the memory and operative for providing instructions to the at least one processor, the at least one processor responsive to the instructions of the program module, the program module operative for:
in response to receiving fuelling information captured by one of a plurality of fuelling station terminals such, each fuelling station terminal associated with a fueling station, the fuelling information comprising an amount of fuel that was purchased for the vehicle at the fuelling station, storing the fuelling information in a fuelling entry associated with the vehicle;
in response to receiving jurisdiction crossing information captured by a remote device related to the vehicle crossing a border from a first jurisdiction to a second jurisdiction, the jurisdictional crossing information identifying the first jurisdiction and a mileage amount at the time the vehicle crossed the border, store the received jurisdiction crossing information in a jurisdiction entry associated with the vehicle; and
using the fuelling entries and jurisdictional entries associated with the vehicle, determining a total amount of fuel purchased for the vehicle within a time period and allocate portions of the total amount of fuel purchased to the jurisdictions within which the vehicle has traveled based on distances traveled by the vehicle in each of the jurisdictions.

31. A computer readable memory medium having recorded thereon statements and instructions for execution by a data processing system to carry out the method of claim 24.
